(19) United States
(12) Patent Application Publication
(10) Pub. No.: US 2007/0036058 A1
(43) Pub. Date: Feb. 15, 2007

(54) Method and unit for separating light and optical pickup device and optical recording/playback apparatus based thereon

(75) Inventors: Yoshiki Okamoto, Kanagawa (JP); Katsuhiro Seo, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/500,413

(22) Filed: Aug. 8, 2006

(30) Foreign Application Priority Data
Aug. 15, 2005 (JP) 2005-235456
Jul. 11, 2006 (JP) 2006-190628

(51) Int. Cl. G11B 7/135

(52) U.S. Cl. 369/112.06; 369/112.28

(57) ABSTRACT

A method for separating light coming from an illuminated multilayer medium having a plurality of reflective surfaces to reach a light receiver through a focusing lens includes the steps of splitting the light traveling toward the light receiver through the focusing lens into at least two portions along the optical axis thereof and separating a light component coming from a particular position of the illuminated medium from each of the split portions of the light by removing a light component focused at a position closer to the focusing lens than the focal position of the light component coming from the particular position between the two focal positions and/or removing a light component focused at a position closer to the light receiver than the focal position of the light component coming from the particular position between the two focal positions.

### CROSS REFERENCES TO RELATED APPLICATIONS

The present invention contains subject matter related to Japanese Patent Application JP 2005-235456 filed in the Japanese Patent Office on Aug. 15, 2005, the entire contents of which are incorporated herein by reference.

### BACKGROUND OF THE INVENTION

1. Field of the Invention

The present invention relates to methods and units for separating light for use in, for example, the recording/playback of multilayer optical recording media, and also relates to optical pickup devices and optical recording/playback apparatuses based on the methods and units for separating light. In particular, the present invention relates to a method and unit for separating light of interest from light coming from an illuminated medium having a plurality of reflective surfaces by removing unnecessary light entering a light-receiving optical system after being reflected by surfaces other than the reflective surface of interest, and also relates to an optical pickup device and an optical recording/playback apparatus based on the method and unit for separating light.

2. Description of the Related Art

Optical recording media (including magneto-optical recording media), typified by compact discs (CDs) and digital versatile discs (DVDs), are widely used as media for storing information such as audio information, video information, data, and programs. Larger-capacity optical recording media and optical recording/playback apparatuses for recording/playback of such media have been demanded for storage of information with higher sound and image qualities and higher volumes.

An optical recording/playback apparatus for recording and/or playback of such optical recording media includes, for example, a light source such as a semiconductor laser, a light-splitting element such as a beam splitter, an objective lens, a focusing lens, and a light receiver such as a photodetector. Light emitted from the light source passes through the light-splitting element and is focused onto a recording layer of an optical recording medium by the objective lens. The light is then reflected by the recording layer, is split by the light-splitting element, and is collected onto the light receiver by the focusing lens.

Multilayer optical recording media with a plurality of recording layers have been proposed to achieve higher capacities. For this type of recording medium, a particular recording layer is illuminated with light, such as laser light, as a light spot for recording/playback. This light, however, is also reflected by the adjacent recording layers and the interface between the outermost layer and air. A light receiver thus undesirably receives the unnecessary light reflected by the adjacent recording layers and the interface.

Such unnecessary light can cause problems such as deterioration of radio frequency (RF) signals and offset of servo signals. In particular, the interference of the light reflected by the adjacent recording layers can undesirably cause deterioration of signal-playback characteristics for optical recording media with higher recording densities and capacities than DVDs because such media have recording layers stacked at narrower pitches. Thus, methods for removing such unnecessary light have been demanded.

Japanese Unexamined Patent Application Publication No. 2005-63595, for example, proposes a method for removing light reflected by adjacent recording layers of a multilayer recording medium using a light shield. A light-shielding region of the light shield is disposed in a small area on an optical axis to selectively remove light reflected by the recording layers other than the recording layer of interest. For example, a pin hole is provided in the vicinity of the focal point of light reflected by the recording layer of interest to remove unnecessary light, thereby reducing the effect of the light reflected by the other recording layers.

### SUMMARY OF THE INVENTION

According to the method disclosed in the publication above, however, it is difficult to receive a light component reflected by the recording layer of interest and traveling along the optical axis and thus to detect all signal light of interest. For example, it is difficult to selectively receive all light of interest using a light shield as described above if side spots for servo tracking or address reading are provided using a diffraction grating. On the other hand, unnecessary light is difficult to completely remove using a pinhole.

Accordingly, it is desirable to provide a method and unit for allowing reliable reception of light reflected at a particular position of an illuminated medium, for example, light reflected by a recording layer of interest of a multilayer optical recording medium, by removing unnecessary light reaching a light receiver after being reflected by the recording layers other than the recording layer of interest. In addition, it is desirable to provide an optical pickup device and an optical recording/playback apparatus that use the method and unit for separating light to suppress the effect of the light reflected by the other recording layers in the recording/playback of the multilayer optical recording medium.

According to an embodiment of the present invention, there is provided a method for separating light coming from an illuminated multilayer medium having a plurality of reflective surfaces to reach a light receiver through a focusing lens. This method includes the steps of splitting the light traveling toward the light receiver through the focusing lens into at least two portions along the optical axis thereof and separating a light component coming from a particular position of the illuminated medium from each of the split portions of the light by removing a light component focused at a position closer to the focusing lens than the focal position of the light component coming from the particular position between the two focal positions and/or removing a light component focused at a position closer to the light receiver than the focal position of the light component coming from the particular position between the two focal positions.

According to another embodiment of the present invention, there is provided a light-separating unit including a separating part for removing, from light coming from an illuminated multilayer medium having a plurality of reflective surfaces to reach a light receiver through a focusing lens, a light component focused at a position closer to the focusing lens than the focal position of a light component coming from a particular position of the illuminated medium between the two focal positions and/or removing a light component focused at a position closer to the light receiver than the focal position of the light component coming from the particular position between the two focal positions.

According to another embodiment of the present invention, there is provided an optical pickup device including a light source for emitting light, a light receiver, and an optical system. The optical system includes an objective lens, a focusing lens, a splitting part, and a light-separating unit. The objective lens is disposed opposite a multilayer optical recording medium having a plurality of reflective surfaces. The light emitted from the light source is guided to the objective lens and is made incident at a predetermined position of the optical recording medium. The focusing lens collects the light coming from the optical recording medium through the objective lens onto the light receiver. The splitting part splits the light traveling toward the light receiver through the focusing lens into at least two portions along the optical axis thereof. The light-separating unit separates a light component reflected by a recording layer of interest of the optical recording medium from each of the split portions of the light by removing a light component focused at a position closer to the focusing lens than the focal position of the light component reflected by the recording layer of interest between the two focal positions and/or removing a light component focused at a position closer to the light receiver than the focal position of the light component reflected by the recording layer of interest between the two focal positions.

According to another embodiment of the present invention, there is provided an optical recording/playback apparatus including a light source for emitting light, a light receiver, and an optical system for recording and/or playback. The optical system includes an objective lens, a focusing lens, a splitting part, and a light-separating unit. The objective lens is disposed opposite a multilayer optical recording medium having a plurality of reflective surfaces. The light emitted from the light source is guided to the objective lens and is made incident at a predetermined position of the optical recording medium. The focusing lens collects the light coming from the optical recording medium through the objective lens onto the light receiver. The splitting part splits the light traveling toward the light receiver through the focusing lens into at least two portions along the optical axis thereof. The light-separating unit separates a light component reflected by a recording layer of interest of the optical recording medium from each of the split portions of the light by removing a light component focused at a position closer to the focusing lens than the focal position of the light component reflected by the recording layer of interest between the two focal positions and/or removing a light component focused at a position closer to the light receiver than the focal position of the light component reflected by the recording layer of interest between the two focal positions.

According to the embodiments described above, a light component coming from a predetermined position of an illuminated medium, for example, from a predetermined recording layer of an optical recording medium, is separated from light components coming from other recording layers, that is, from different depths, on the basis of differences in focal position in the area between a focusing lens and a light receiver. The light receiver can thus reliably receive only the light coming from the recording layer of interest.

In the embodiments described above, the light passing through the focusing lens is split into at least two portions along the optical axis thereof. Light components focused at positions other than the focal position of the light component of interest are then removed on the basis of differences in focal position by, for example, blocking, reflection, refraction, or polarization. This allows reliable removal of the light components coming from positions deviating along the optical axis from the position from which the light component of interest comes.

It is difficult to receive all light reflected by the recording layer of interest by, for example, partially blocking the light on the basis of differences in beam size without splitting the light, or by simply splitting the light. Using such methods, additionally, unnecessary light is difficult to completely remove.

In contrast, the embodiments of the present invention allow reliable reception of only the light of interest by splitting the light along the optical axis thereof and separating the split light on the basis of differences in focal position.

As described above, the method and unit for separating light according to the embodiments of the present invention allow removal of unnecessary light and reliable reception of light coming from a particular position of an illuminated multilayer medium having a plurality of reflective surfaces.

In the recording/playback of a multilayer optical recording medium having a plurality of reflective surfaces, the optical pickup device and the optical recording/playback apparatus according to the embodiments of the present invention can suppress the effect of light reflected by the layers other than the recording layer of interest.

### BRIEF DESCRIPTION OF THE DRAWINGS

FIG. 1 is a schematic diagram of an example of an optical recording/playback apparatus including an optical pickup device according to an embodiment of the present invention;

FIG. 2 is a schematic sectional view of an example of an optical recording medium;

FIGS. 3A and 3B are diagrams illustrating the optical paths of unnecessary light components reflected by an illuminated medium;

FIGS. 4A and 4B are diagrams illustrating a method for separating light according to an embodiment of the present invention;

FIG. 5 is a schematic diagram of an optical system including a light-separating unit according to an embodiment of the present invention;

FIG. 6 is a schematic diagram of an optical system including a light-separating unit according to another embodiment of the present invention;

FIGS. 7A and 7B are a schematic diagram of an optical system based on a method for separating light according to another embodiment of the present invention and a diagram illustrating how light is separated in the method for separating light according to this embodiment, respectively;

FIG. 8 is a schematic diagram of an optical system based on a method for separating light according to another embodiment of the present invention;

FIGS. 9A, 9B, and 9C are a schematic diagram of an optical system based on a method for separating light according to another embodiment of the present invention, another schematic diagram of the optical system, and a diagram illustrating how light is separated in the method for separating light according to this embodiment, respectively;

FIG. 10 is a schematic diagram of an optical system based on a method for separating light according to another embodiment of the present invention;

FIG. 11 is a schematic diagram of an optical system based on a method for separating light according to another embodiment of the present invention;

FIG. 12 is a schematic diagram of an optical system based on a method for separating light according to another embodiment of the present invention;

FIGS. 13A and 13B are another schematic diagram of the optical system based on the method for separating light according to this embodiment and a diagram illustrating how light is separated in the method for separating light according to this embodiment, respectively;

FIG. 14 is another diagram illustrating how light is separated in the method for separating light according to this embodiment;

FIG. 15 is a diagram illustrating how light is separated in a method for separating light according to another embodiment of the present invention;

FIG. 16 is a diagram illustrating how light is separated in a method for separating light according to another embodiment of the present invention;

FIG. 17 is a diagram illustrating the change of polarization direction using a half wave plate;

FIGS. 18A to 18C are diagrams illustrating polarization directions in the method for separating light according to this embodiment;

FIG. 19 is a diagram illustrating how light is separated in a method for separating light according to another embodiment of the present invention;

FIG. 20 is a diagram illustrating how light is separated in a method for separating light according to another embodiment of the present invention;

FIGS. 21A to 21C are diagrams illustrating polarization directions in the method for separating light according to this embodiment;

FIG. 22 is a diagram illustrating how light is separated in a method for separating light according to another embodiment of the present invention; and

FIGS. 23A, 23B, and 23C are a schematic diagram of an optical system based on a method for separating light according to another embodiment of the present invention, another schematic diagram of the optical system, and a diagram illustrating how light is separated in the method for separating light according to this embodiment, respectively.

### DESCRIPTION OF THE PREFERRED EMBODIMENTS

Preferred embodiments of the present invention will now be described, although the invention is not limited to the embodiments below.

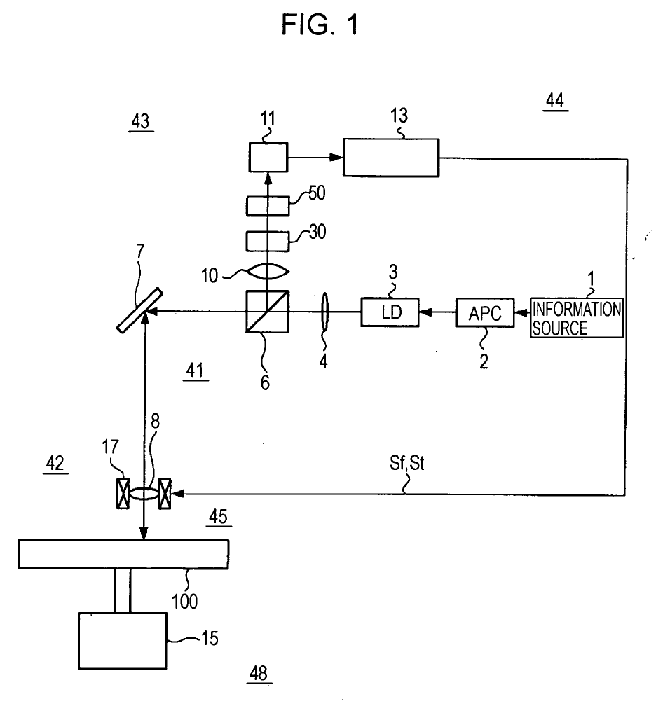

First, an example of an optical recording/playback apparatus including an optical pickup device based on a method and unit for separating light according to an embodiment of the present invention will be described below with reference to FIG. 1. FIG. 1 is a schematic diagram of the optical recording/playback apparatus.

In the example illustrated in FIG. 1, information fed from an information source 1 is recorded on a disc-shaped optical recording medium 100. A light beam is emitted from a light source 3 including, for example, a laser diode (LD) and is modulated according to information signals fed from the information source 1. An automatic power controller (APC) 2 controls the output of the light beam. The light beam is then collimated by a collimator lens 4 of an optical unit 41 to enter a head unit 42 via a beam splitter 6 and a mirror 7. A drive unit 45 includes, for example, an actuator 17 for focusing and tracking. The head unit 42 includes an optical system mounted on the actuator 17 to illuminate the optical recording medium 100 with the light beam. This optical system includes an objective lens 8 composed of an aspherical lens or a lens group. The head unit 42 allows the light exiting the optical unit 41 to impinge on a particular recording layer of the optical recording medium 100 on which information is to be recorded.

A movement mechanism 48 includes a rotating unit 15 which holds and rotates the optical recording medium 100. A horizontal movement mechanism (not shown), for example, moves the optical system of the head unit 42 along the recording surface of the optical recording medium 100. The movement mechanism 48 cooperates with the horizontal movement mechanism to scan, for example, spiral or concentric recording tracks with the light traveling through the head unit 42 along the surface of the optical recording medium 100.

The light reflected by the optical recording medium 100 passes through the head unit 42 and is reflected by the beam splitter 6. The light then passes through a focusing lens 10 and is detected by a detecting unit 43 including a light receiver 11 such as a photodetector.

In this embodiment, the optical recording/playback apparatus further includes a splitting part 30 and a light-separating unit 50 disposed between the focusing lens 10 and the light receiver 11. The splitting part 30 splits the light into at least two portions along the optical axis thereof. The light-separating unit 50 separates a light component reflected by the recording layer of interest of the optical recording medium 100 from each of the split portions of the light.

The detected amounts of light are input to a servo circuit 13 of a control unit 44 and are converted into focusing control signals Sf based on, for example, an astigmatic method or a knife edge method and tracking control signals St based on, for example, a push-pull method. These controls signals Sf and St are fed to the actuator 17 of the drive unit 45 to, for example, correct the focusing and tracking of the objective lens 8. Thus, a constant distance is maintained between the objective lens 8 and the optical recording medium 100 to enable successful recording on a predetermined track.

In playback, or for a playback-only apparatus, light emitted from the light source 3 impinges on the optical recording medium 100 through the same optical path. The light receiver 11 detects light reflected by the optical recording medium 100 to generate and output playback signals through a circuit for detecting the playback-signals (not shown).

The detected amounts of light are also partially fed to the servo circuit 13 of the drive unit 44 for focusing control and tracking control.

A diffractive element, for example, may be disposed between the collimator lens 4 and the beam splitter 6 to split the light emitted from the light source 3 into at least two light beams which impinge on the optical recording medium 100. One of the two light beams may be used for recording and/or playback while the other light beam may be used for focusing control or tracking control.

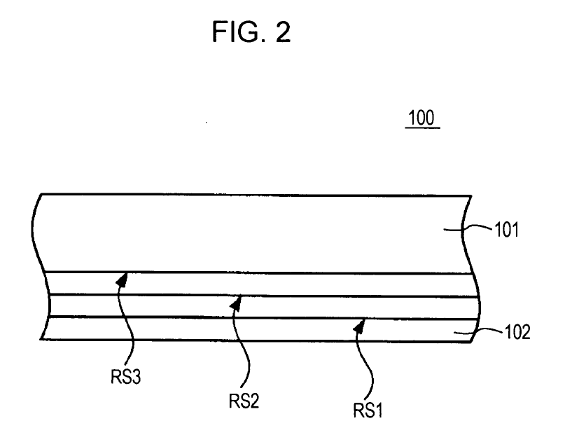

The optical recording medium 100 used for recording/playback with the optical recording/playback apparatus may be a multilayer recording medium, for example, a recording medium having three recording layers as shown in FIG. 2. This recording medium 100 includes a substrate 101 and first to third recording layers stacked thereon in the order in which light travels through the recording layers. The first to third recording layers have reflective surfaces RS1 to RS3, respectively, which reflect light. A transparent protective layer 102 is disposed on the reflective surface RS1 of the first recording layer. The surface of the protective layer 102 is the interface to air. That is, the optical recording medium 100 has a multilayer structure with the three reflective surfaces RS1 to RS3. The term “reflective surface” herein also includes surfaces of films with some transparency, for example, translucent films.

The optical recording/playback apparatus according to this embodiment may be applied to various types of optical recording media, including read-only media with pits, recordable media with a dye layer, and rewritable media of magneto-optical type or phase-change type. In addition, transparent interlayer adhesive films (not shown), for example, may be disposed between the recording layers.

The optical recording/playback apparatus according to this embodiment may be applied not only to optical recording media having three recording layers, as exemplified in FIG. 2, but also to optical recording media having one, two, or four or more recording layers. For optical recording media having a singe recording layer, light reflected by the recording layer can be separated from light reflected by the surface of a protective layer.

The optical recording medium 100 may also be illuminated with light from the substrate 101 side, rather than from the protective layer 102 side.

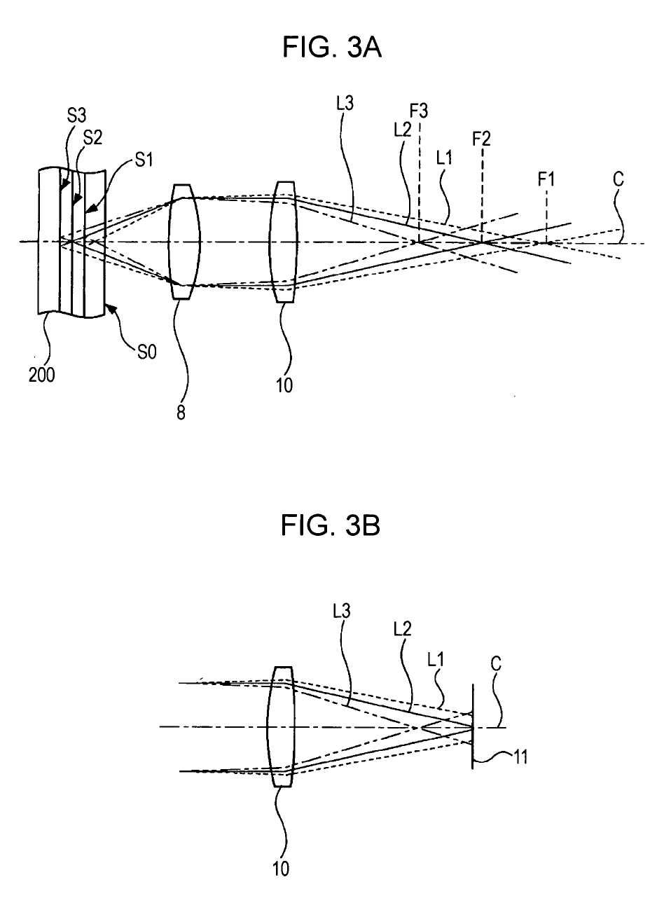

Focal positions of light reflected by recording layers of a multilayer optical recording medium when the medium is illuminated will be described below with reference to FIGS. 3A and 3B.

FIG. 3A is a schematic sectional view, taken along an optical axis C, of an optical system for collecting light reflected by an optical recording medium onto a light receiver. In the example illustrated in FIG. 3A, an illuminated medium 200 has a multilayer structure similar to the multilayer optical recording medium 100, having a first reflective surface S1, a second reflective surface S2, and a third reflective surface S3. Light components reflected by the first reflective surface S1, the second reflective surface S2, and the third reflective surface S3 are indicated by the broken line L1, the solid line L2, and the two-dot chain line L3, respectively. These light components L1 to L3 pass through the objective lens 8 to enter the focusing lens 10, which focuses the light components L1 to L3. The second recording layer of the multilayer optical recording medium 100 in FIG. 2, for example, is herein assumed to be the recording layer used for recording/playback. The surface of the second recording layer of the multilayer optical recording medium 100 corresponds to the second reflective surface S2 of the illuminated medium 200. The light component L2 reflected by the second reflective surface S2 is focused at a focal position F2. The light receiver 11 (not shown in FIG. 3A) is disposed further away from the focusing lens 10 than the focal position F2. The first reflective surface S1 is closer to an outer surface S0 than the second reflective surface S2. The light component L1 reflected by the first reflective surface S1 is focused at a focal position F1 further away from the focusing lens 10 than the focal position F2, that is, on the light receiver 11 side. The third reflective surface S3 is further away from the outer surface S0 than the second reflective surface S2. The light component L3 reflected by the third reflective surface S3 is focused at a focal position F3 closer to the focusing lens 10 than the focal position F2, that is, on the focusing lens 10 side.

FIG. 3B illustrates the light components L1 to L3 in the case where the light receiver 11 is disposed at the focal position F2. The light components L1 and L3 overlap the light component L2 on the light receiver 11. FIG. 3B suggests that the overlapping light components L1 and L3 adversely affect signals if the illuminated medium 200 is, for example, an optical recording medium.

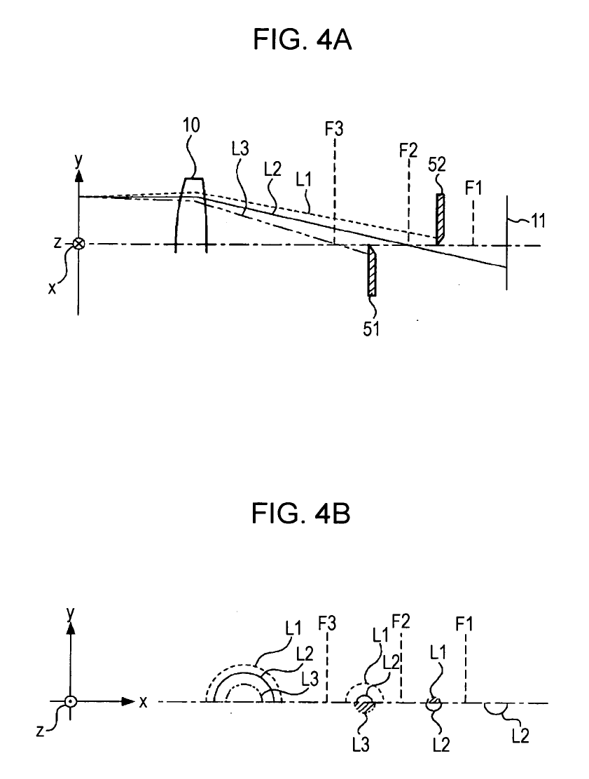

The method for separating light according to this embodiment will be described below with reference to FIGS. 4A and 4B, where components corresponding to those in FIG. 3 are indicated by the same reference numerals to avoid redundant description. In FIG. 4A, the z-axis indicates the optical axis, the y-axis indicates a direction parallel to a cross-section perpendicular to the optical axis, and the x-axis indicates a direction parallel to the cross-section and perpendicular to the y-axis direction. In FIGS. 4A and 4B, the light is split into upper and lower portions along the xz-plane, and only the upper portion of the light (on the plus side of the y-axis) is illustrated.

In the example illustrated in FIGS. 4A and 4B, a separating part 51 is disposed between the focal position F2 and the focal position F3, which is closer to the focusing lens 10 than the focal position F2, and another separating part 52 is disposed between the focal position F2 and the focal position F1, which is further away from the focusing lens 10 than the focal position F2. The separating parts 51 and 52 used may be, for example, light shields. In this case, the separating part 51 blocks the light on the lower side of the xz-plane while the separating part 52 blocks the light on the upper side of the xz-plane.

FIG. 4B is a sectional view of the light components L1 to L3 which is taken along the xy-plane at different positions on the z-axis in FIG. 4A. The light components L1 to L3 overlap each other between the focusing lens 10 and the focal position F3. The light component L3 travels across the xz-plane to the lower side thereof between the focal positions F3 and F2. The light components L1 and L2 overlap each other on the upper side of the xz-plane at the position where the separating part 51 is disposed. The separating part 51 blocks and removes the light component L3 traveling across the xz-plane to the lower side thereof (indicated by the hatched area in FIG. 4B).

The light component L2 travels across the xz-plane to the lower side thereof between the focal positions F2 and F1 and only the light component L1 remains on the upper side of the xz-plane. The separating part 52 blocks and removes the light component L1, as indicated by the hatched area in FIG. 4B. Hence, the light receiver 11 receives only the light component L2 reflected by the recording layer of interest. The portions of the light component L2 split along the optical axis are thus all separated from the other light components L2 to L3 to reach the light receiver 11 without being affected by the separating parts 51 and 52.

In the method for separating light according to this embodiment, as described above, the separating parts 51 and 52 are disposed between the focal position F2 of the light component L2 of interest and the focal positions F1 and F3 of the unnecessary light components L1 and L3, respectively. These separating parts 51 and 52 can reliably remove the light components L1 and L3 without affecting the light component L2 to extract the light component L2 at a light-receiving position.

The light is split into two portions along the xz-plane in the example illustrated in FIGS. 4A and 4B, although the light may also be split into three or more portions. In addition, the light does not necessarily have to be spatially split. That is, the light component of interest may be separated without spatially splitting the light by, for example, controlling the polarization of the light using an optical rotator or wave plate, as will be described in detail in, for example, a sixth embodiment. After the light passes through the optical rotator or wave plate, the light component of interest may be separated using a light-separating unit including, for example, a polarizing filter portion. Thus, the term “split” herein includes not only the spatial splitting of light, but also the division of light into regions with different optical properties.

The light component of interest may also be separated without using the separating part 52. For example, the light receiver 11 may be disposed between the focal positions F2 and F1 instead of the separating part 52 in FIG. 4A. In this case, the light-receiving region of the light receiver 11 may be divided along the x-axis so that the light receiver 11 can reliably receive only light reflected at a particular position, for example, only the light reflected by the second recording layer of the optical recording medium 100 described above.

In addition, light can be separated without using the separating part 51 if the method for separating light according to this embodiment is applied to an illuminated medium having two reflective surfaces, for example, an optical recording medium having two recording layers. In this case, light reflected by the inner recording layer can be separated without the need for removing light reflected inside the inner recording layer. The light component L2 can thus be reliably separated by inserting only the separating-part 52 between the focal position F2 of the light component L2 of interest and the focal position F1 on the light receiver 11 side so that the light receiver 11 can receive the light component L2. Similarly, the method for separating light according to this embodiment may be applied to an optical recording medium having a single recording layer to separate light reflected by the recording layer from light reflected by a protective layer.

For the method and unit for separating light, the optical pickup device, and the optical recording/playback apparatus according to this embodiment, as described above, only the light component of interest can be guided to the light receiver 11 by separating the light using the separating part 51 and/or the separating part 52. The use of the separating part 51 and/or the separating part 52 depends on conditions such as the layer structure of the illuminated medium used (or the optical recording medium used) and which recording layer reflects the light component of interest.

Next, light-separating units based on-the method for separating light described above according to embodiments of the present invention will be described below.

### First Embodiment

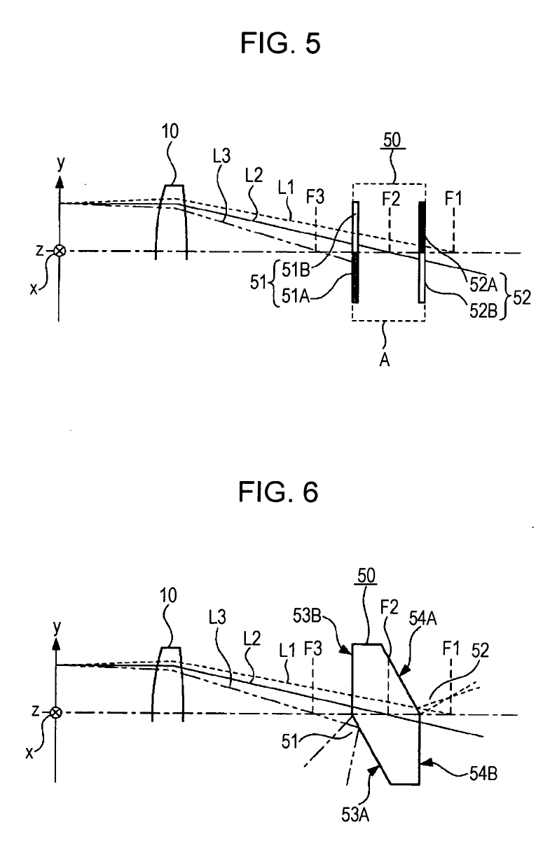

FIG. 5 is a schematic diagram of a light-separating unit and an optical system including the unit according to a first embodiment of the present invention. In FIG. 5, components corresponding to those in FIG. 4 are indicated by the same reference numerals to avoid redundant description.

In this embodiment, a light-separating unit 50 includes a separating part 51 disposed between the focal position F3 of the light component L3 and the focal position F2 of the light component L2 of interest and another separating part 52 disposed between the focal position F2 of the light component L2 and the focal position F1 of the light component L1. The separating part 51 has a non-transparent region 51A and a transparent region 51B. The separating part 52 has a non-transparent region 52A and a transparent region 52B. The separating parts 51 and 52 may be separately arranged, supported by a support at a predetermined interval, or integrated with a transparent member (not shown), for example, disposed therebetween, as indicated by the broken line A.

The non-transparent region 51A of the separating part 51 can block and remove the light component L3 because the light component L3 travels to the lower side of the xz-plane through the focal position F3. The non-transparent region 52A of the separating part 52 can block and remove the light component L1 because the light component L1 remains on the upper side of the xz-plane before traveling through the focal position F1.

This structure allows only a light component reflected at a particular position of an illuminated medium, for example, only a light component reflected by the recording layer of interest of an optical recording medium, to pass through the light-separating unit 50 while reliably removing light components reflected by the layers other than the recording layer of interest. The light receiver 11 can therefore reliably detect only the light component reflected by the recording layer of interest.

The non-transparent regions 51A and 51B of the separating parts 51 and 52, respectively, may have any structure that can prevent light from traveling in a straight line; for example, they may also be a reflective surface, a refractive surface, a scattering surface, or a diffractive surface.

Also, the light component L1 reflected by the reflective surface S1 or the light component L3 reflected by the reflective surface S3 may be separated. In such cases, the light-separating unit 50 may be translated along, for example, the optical axis in the z-axis direction in FIG. 5 so that the separating parts 51 and 52 are located at appropriate positions. For example, the light component L3 can be separated by disposing the separating part 52 between the focal positions F3 and F2, and the light component L1 can be separated by disposing the separating part 51 between the focal positions F1 and F2.

### Second Embodiment

FIG. 6 is a schematic diagram of a light-separating unit and an optical system including the unit according to a second embodiment of the present invention. In FIG. 6, components corresponding to those in FIG. 4 are indicated by the same reference numerals to avoid redundant description.

In this embodiment, the light-separating unit 50 is a prism-shaped integral unit. In FIG. 6, the light-separating unit 50 has a reflective surface 53A below the xz-plane on the light-entering side, a transparent surface 53B above the xz-plane on the light-entering side, a refractive surface 54A above the xz-plane on the light-exiting side, and a transparent surface 54B below the xz-plane on the light-exiting side. The reflective surface 53A reflects the light component L3. The refractive surface 54A deflects the optical path of the light component L1 away from the optical axis. The reflective surface 53A and the refractive surface 54A are inclined at a predetermined angle to a plane perpendicular to the optical axis, that is, the z-axis, to change the optical paths of the unnecessary light components L1 and L3 to appropriate directions.

The prism-shaped light-separating unit 50 is disposed between the focusing lens 10 and the light receiver 11. This simple arrangement allows the light receiver 11 to reliably receive only a light component reflected by the layer of interest while reliably removing unnecessary light components reflected by the other layers, which would otherwise overlap the light component of interest in the related art.

Additional light receivers may be disposed on the optical paths of the light components L1 and L3 to separately receive them. This arrangement, for example, allows the reception of signals from the individual recording layers of a three-layer optical recording medium. As in the first embodiment described above, additionally, the light-separating unit 50 may be translated along, for example, the optical axis in the z-axis direction so that the light receiver 11 can receive only the light component L1 or L3.

The prism shape of the light-separating unit 50 is not limited to the illustrated example, and various modifications are permitted. For example, the angles of the transparent surfaces 53B and 54B may be adjusted so that the light component L2 travels in a straight line, or the angles of the reflective surface 53A and the refractive surface 54A may be inclined so as to change the direction in which light travels in, for example, the x-axis direction.

The light-separating unit 50 may thus be composed of a single optical element such as a prism, or may also be composed of a combination of optical elements such as a light-shielding portion, a reflective surface, and a transparent member.

In the description of the first and second embodiments, the light passing through the focusing lens 10 is split into two portions along the xz-plane, and the light component of interest is separated from the upper portion of the light. In these embodiments, the light component of interest can also be separated from the lower portion of the light on the split optical paths so that the light receiver 11 can receive only the light component of interest. The light can be split by, for example, placing a prism with a ridge thereof arranged along the xz-plane. This prism can spatially split the light components L1 to L3 along the optical axis.

The split portions of the light component L2 can be separated and combined so that the light receiver 11 can reliably receive only the light component L2. When applied to an optical pickup device or an optical recording/playback apparatus to perform the recording/playback of a multilayer recording medium, the light-separating unit 50 can reliably remove light components reflected by the layers other than the recording layer of interest to suppress a decrease in recording/playback characteristics.

Next, optical systems including a combination of a splitting part for splitting light along the optical axis thereof and a light-separating unit according to embodiments of the present invention will be described below.

### Third Embodiment

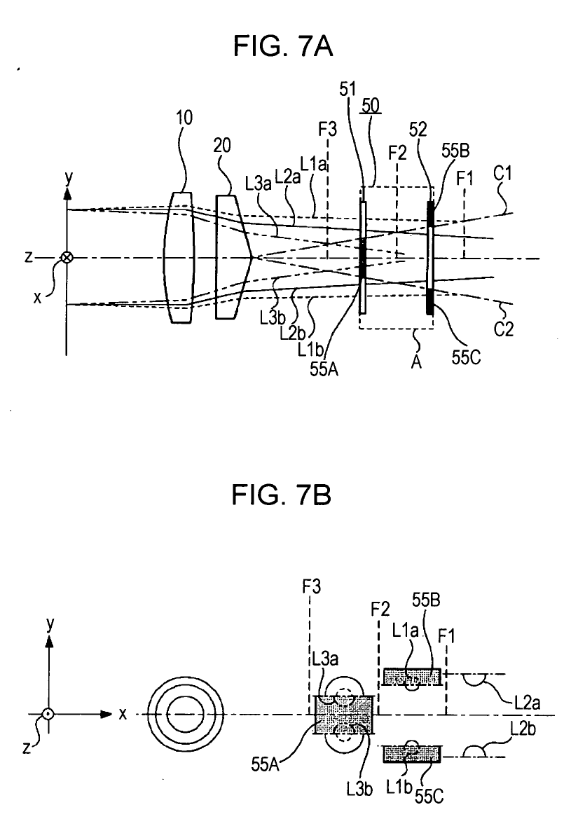

FIGS. 7A and 7B are schematic diagrams of a light-separating unit and an optical system including the unit according to a third embodiment of the present invention. In FIGS. 7A and 7B, components corresponding to those in FIG. 4 are indicated by the same reference numerals to avoid redundant description.

In this embodiment, a prism 20 is disposed on the light-exiting side of the focusing lens 10. This prism 20 has a transparent surface on the light-entering side and a refractive structure on the light-exiting side. The refractive structure splits light along the xz-plane so that the optical axes of the split portions of the light deviate away from the z-axis to the y-axis direction, as indicated by the one-dot chain lines C1 and C2.

In FIG. 7A, the prism 20 splits the light components L1, L2, and L3 into light components L1a and L1b, L2a and L2b, and L3a and L3b, respectively. The light components L1a to L3a have the optical axis Cl while the light components L1b to L3b have the optical axis C2. The light-separating unit 50 is disposed as in the embodiments described above, that is, with a light-shielding portion 55A thereof disposed between the focal positions F2 and F3 and light-shielding portions 55B and 55C thereof disposed between the focal positions F2 and F1. The light-shielding portion 55A blocks the area between the optical axes C1 and C2. The light-shielding portions 55B and 55B block the areas outside the optical axes C1 and C2, respectively.

The light-shielding portion 55A of the separating part 51 blocks the light components L3a and L3b, which are reflected inside the layer of interest. The light-shielding portions 55B and 55c of the separating part 52 block the light components L1a and L1b, respectively, which are reflected outside the layer of interest. This arrangement can reliably remove the unnecessary light. The light receiver 11 can thus receive only the light components L2a and L2b, which are reflected by the recording layer of interest.

Accordingly, the light components L2a to L2b may be combined so that the light receiver 11 can detect all light reflected by the layer of interest.

The simple optical system with the prism 20 and the light-separating unit 50 can suppress a decrease in recording/playback characteristics when applied to an optical pickup device or an optical recording/playback apparatus to perform the recording/playback of a multilayer recording medium.

### Fourth Embodiment

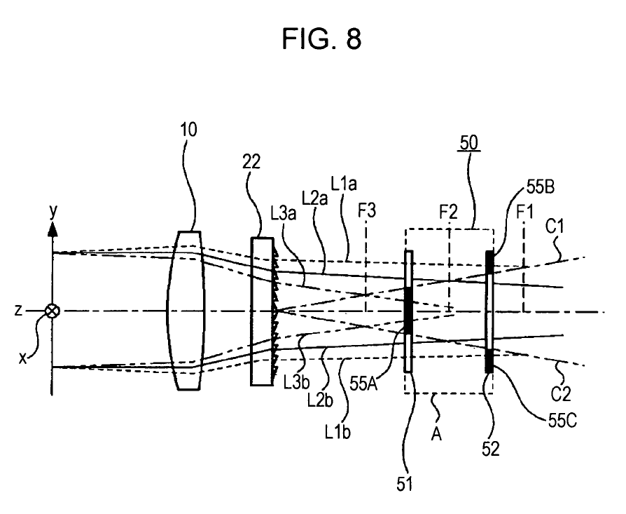

FIG. 8 is a schematic diagram of a light-separating unit and an optical system including the unit according to a fourth embodiment of the present invention. In FIG. 8, components corresponding to those in FIGS. 7A and 7B are indicated by the same reference numerals to avoid redundant description.

In this embodiment, a diffractive element 22 is used as the splitting part 30 instead of the prism 20 used in the third embodiment. This diffractive element 22 splits the light exiting the focusing lens 10 so that the optical axes of the split portions of the light deviate away from the z-axis to the y-axis direction, as indicated by the one-dot chain lines C1 and C2. The diffractive element 22 thus splits the light components L1, L2, and L3 into the light components L1a and L1b, L2a and L2b, and L3a and L3b, respectively.

The light-shielding portion 55A of the separating part 51 blocks the light components L3a and L3b, which are reflected inside the layer of interest. The light-shielding portions 55B and 55c of the separating part 52 block the light components L1a and L1b, respectively, which are reflected outside the layer of interest. This arrangement can reliably remove the unnecessary light. The light receiver 11 can thus receive only the light components L2a and L2b, which are reflected by the recording layer of interest.

Accordingly, the light components L2a to L2b may be combined so that the light receiver 11 can detect all light reflected by the layer of interest.

The simple optical system with the diffractive element 22 and the light-separating unit 50 can suppress a decrease in recording/playback characteristics when applied to an optical pickup device or an optical recording/playback apparatus to perform the recording/playback of a multilayer recording medium.

### Fifth Embodiment

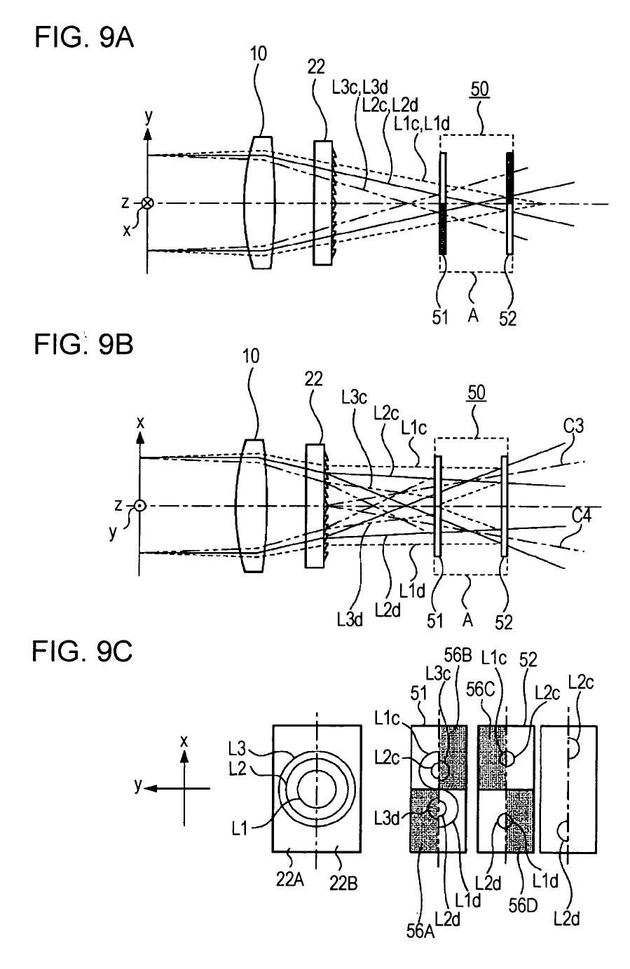

FIGS. 9A and 9B are schematic diagrams of a light-separating unit and an optical system including the unit according to a fifth embodiment of the present invention. FIG. 9A is a plan view of the yz-plane in the x-axis direction. FIG. 9B is a plan view of the xz-plane in the y-axis direction. In FIGS. 9A and 9B, components corresponding to those in FIG. 8 are indicated by the same reference numerals to avoid redundant description.

In this embodiment, the diffractive element 22 used as the splitting part 30 in the fourth embodiment is disposed so as to split light in the x-axis direction. In FIG. 9B, the diffractive element 22 splits the light exiting the focusing lens 10 so that the optical axes C3 and C4 of the split portions of the light deviate away from the z-axis to the x-axis direction. The diffractive element 22 thus splits the light components L1, L2, and L3 into the light components L1a and L1b, L2a and L2b, and L3a and L3b, respectively.

Referring to FIG. 9C, the diffractive element 22 has a diffractive region 22A that diffracts light in the plus direction on the x-axis, that is, along the optical axis C3, and a diffractive region 22B that diffracts light in the minus direction on the x-axis, that is, along the optical axis C4. The separating part 51 includes light-shielding portions 56A and 56B that block light components L3d and L3c, respectively, reflected inside the layer of interest. The separating part 52 includes light-shielding portions 56C and 56D that block light components L1c and L1d, respectively, reflected outside the layer of interest. This arrangement can reliably remove the unnecessary light. The light receiver 11 can thus receive only light components L2c and L2c reflected by the layer of interest.

Accordingly, the light components L2c to L2d may be combined so that the light receiver 11 can detect all light reflected by the layer of interest.

The simple optical system with the diffractive element 22 and the light-separating unit 50 can suppress a decrease in recording/playback characteristics when applied to an optical pickup device or an optical recording/playback apparatus to perform the recording/playback of a multilayer recording medium.

### Sixth Embodiment

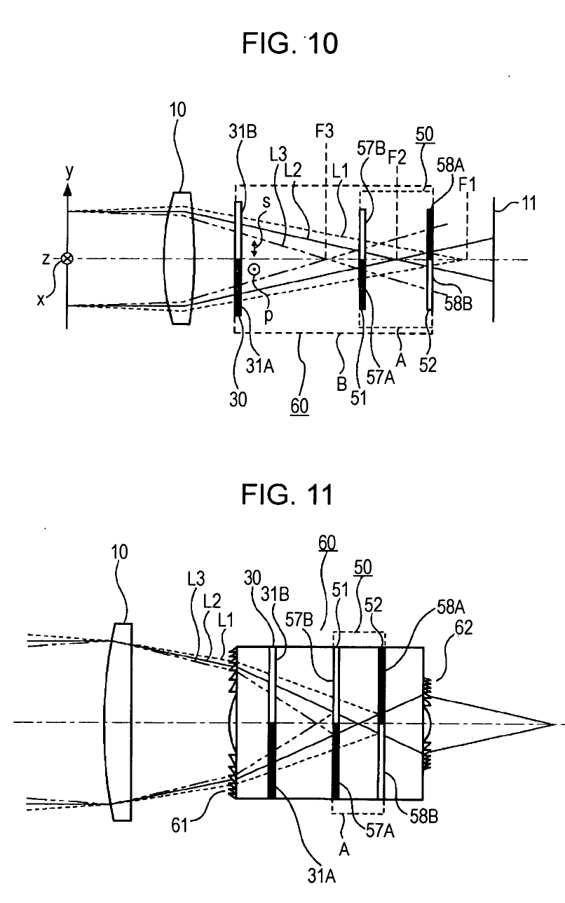

FIG. 10 is a schematic diagram of a light-separating unit and an optical system including the unit according to a sixth embodiment of the present invention. In FIG. 10, components corresponding to those in FIG. 8 are indicated by the same reference numerals to avoid redundant description.

In this embodiment, the separating part 51 includes polarizing filter portions 57A and 57B, and the separating part 52 includes polarizing filter portions 58A and 58B. The splitting part 30 includes an optical rotator or a wave plate, for example, an optical rotator 31A, and a transparent portion 31B. Incident light is selectively allowed to pass through the optical rotator 31A, which is a region that changes the polarization of light. For example, the polarization direction of light passing through the optical rotator 31A is a direction indicated by the arrow p along the x-axis, and the polarization direction of light passing through the transparent portion 31B is a direction indicated by the arrow s along the y-axis. That is, the polarization direction of the light passing through the optical rotator 31A is perpendicular to that of the light passing through the transparent portion 31B. The polarizing filter portions 57A and 58A transmit the light polarized in the direction indicated by the arrow p and do not transmit the light polarized in the direction indicated by the arrow s. The polarizing filter portions 57B and 58B transmit the light polarized in the direction indicated by the arrow s and do not transmit the light polarized in the direction indicated by the arrow p.

Hence, the polarizing filter portion 57A does not transmit the portion of the light component L3 above the xz-plane, and the polarizing filter portion 58A does not transmit the portion of the light component L1 above the xz-plane. The polarizing filter portions 57A and 58A can thus reliably remove the unnecessary light, and only the portion of the light component L2 above the xz-plane passes through the polarizing filter portions 57B and 58B and is received by the light receiver 11.

On the other hand, the polarizing filter portion 57B does not transmit the portion of the light component L3 below the xz-plane, and the polarizing filter portion 58B does not transmit the portion of the light component L1 below the xz-plane. The polarizing filter portions 57B and 58B can thus reliably remove the unnecessary light, and only the portion of the light component L2 below the xz-plane passes through the polarizing filter portions 57A and 58A and is received by the light receiver 11.

Accordingly, the light receiver 11 can detect all light reflected by the layer of interest. The simple optical system with the splitting part 30 and the light-separating unit 50 can suppress a decrease in recording/playback characteristics when applied to an optical pickup device or an optical recording/playback apparatus to perform the recording/playback of a multilayer recording medium.

In this embodiment, the splitting part 30 and the light-separating unit 50 may also be integrated as a light-separating unit 60, as indicated by the broken line B. The simple optical system with the light-separating unit 60, which also has a light-splitting function, can suppress a decrease in recording/playback characteristics in the recording/playback of a multilayer recording medium.

In this embodiment, the light component reflected by the reflective surface of interest may be allowed to pass through the separating parts 51 and 52, that is, the polarizing filter portions 57A and 58A or the polarizing filter portions 57B and 58B, across the optical axis. As in the first and second embodiments, therefore, the light-separating unit 50 may be translated along the optical axis in the z-axis direction so that the light receiver 11 can receive only the light component L1 or L3.

FIG. 11 is a schematic diagram of a light-separating unit integrated with a splitting part according to another embodiment of the present invention. In FIG. 11, components corresponding to those in FIG. 10 are indicated by the same reference numerals to avoid redundant description.

In this embodiment, a light-separating unit 60 having a light-splitting function has a first diffractive lens portion 61 on the light-entering side and a second diffractive lens portion 62 on the light-exiting side. For example, these diffractive lens portions 61 and 62 have a focusing function to reduce the optical path length of light and thus reduce the size of the light-separating unit 60, or to adjust the distance between the light-separating unit 60 and the light receiver 11.

The transparent portion 31B may be replaced with an optical rotator or a wave plate, which depends on the polarization of the light passing through the focusing lens 10. Also, in this case, only the splitting part 30 and the light-separating unit 50 may be integrally provided without the diffractive lens portions 61 and 62.

Accordingly, the light receiver 11 can detect all light reflected by the layer of interest. The simple optical system with the light-separating unit 60 can suppress a decrease in recording/playback characteristics when applied to an optical pickup device or an optical recording/playback apparatus to perform the recording/playback of a multilayer recording medium.

### Seventh Embodiment

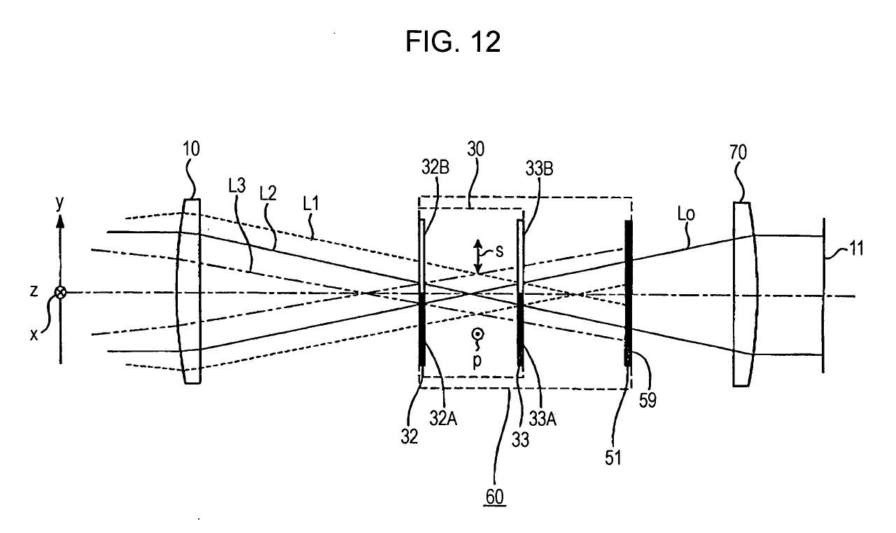

FIG. 12 is a schematic diagram of a light-separating unit and an optical system including the unit according to a seventh embodiment of the present invention. In FIG. 12, components corresponding to those in FIGS. 10 and 11 are indicated by the same reference numerals to avoid redundant description.

In this embodiment, the separating part 51 includes a uniform polarizing filter portion 59, and the splitting part 30 includes two optical rotators or wave plates, for example, a first optical rotator 32 and a second optical rotator 33. The first optical rotator 32 has a first optical rotation region 32A and a second optical rotation region 32B, and the second optical rotator 33 has a first optical rotation region 33A and a second optical rotation region 33B. The first optical rotation region 32A of the first optical rotator 32 and the second optical rotation region 33B of the second optical rotator 33 rotate the polarization direction of light 45° in opposite directions. Similarly, the second optical rotation region 32B of the first optical rotator 32 and the first optical rotation region 33A of the second optical rotator 33 rotate the polarization direction of light 45° in opposite directions.

The polarization direction of light passing through the first optical rotation region 32A of the first optical rotator 32 and the second optical rotation region 33B of the second optical rotator 33 returns to the original polarization direction. The polarization direction of the light is rotated 45° by the first optical rotator 32 and is rotated in the reverse direction in the same amount of rotation by the second optical rotator 33. Similarly, the polarization direction of light passing through the second optical rotation region 32B of the first optical rotator 32 and the first optical rotation region 33A of the second optical rotator 33 returns to the original polarization direction. The polarization direction of the light is rotated 45° by the first optical rotator 32 and is rotated in the reverse direction in the same amount of rotation by the second optical rotator 33.

On the other hand, the polarization directions of light passing through the first optical rotation regions 32A and 33A and light passing through the second optical rotation regions 32B and 33B are rotated in twice the amount of rotation caused in each optical rotation region, that is, rotated to a direction perpendicular to the polarization direction of the incident light.

The polarizing filter portion 59 of the separating part 51 transmits only light polarized in the original polarization direction. This structure allows only the light component L2 to travel toward the light receiver 11. For example, the light component L2 can reach the light receiver 11 through a lens 70, as indicated by the solid lines Lo.

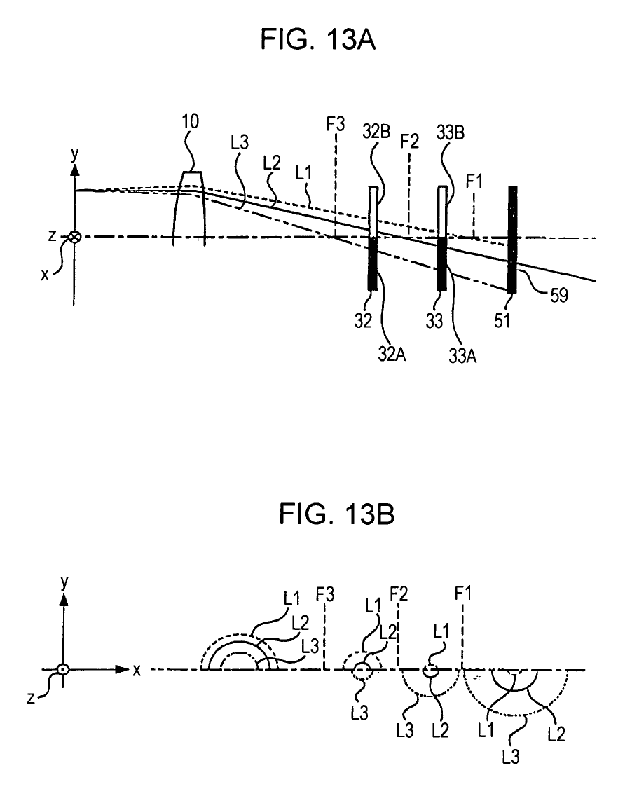

FIG. 13A is a sectional view of the light which is taken along the yz-plane in this embodiment. FIG. 13B is a sectional view of the light which is taken along the xy-plane at different positions on the z-axis. FIGS. 13A and 13B illustrate the light passing through the focusing lens 10 only on the plus side of the y-axis. In FIGS. 13A and 13B, components corresponding to those in FIG. 12 are indicated by the same reference numerals to avoid redundant description.

In FIG. 13A, the first optical rotator 32 is disposed between the focal positions F3 and F2 of the light component L3 and L2, respectively, and the second optical rotator 33 is disposed between the focal positions F2 and F1 of the light component L2 and L1, respectively. The separating part 51 is disposed on the light receiver 11 side.

The light components L1 and L2 pass through the portion of the first optical rotator 32 above the z-axis, that is, the second optical rotation region 32B, while the light component L3 passes through the portion of the first optical rotator 32 below the z-axis, that is, the first optical rotation region 32A. On the other hand, the light components L2 and L3 pass through the first optical rotation region 33A while the light component L1 passes through the second optical rotation region 33B.

Hence, the polarization direction of the light component L3 is rotated 45° clockwise, for example, when the light component L3 passes through the first optical rotator 32, and is further rotated 45° clockwise when the light component L3 passes through the second optical rotator 33 to enter the polarizing filter portion 59 of the separating part 51.

Similarly, the polarization direction of the light component L1 is rotated 45° counterclockwise, for example, when the light component L1 passes through the first optical rotator 32, and is further rotated 45° counterclockwise when the light component L1 passes through the second optical rotator 33 to enter the polarizing filter portion 59 of the separating part 51.

In contrast, only the light component L2 passes through the second optical rotation region 32B of the first optical rotator 32 and the first optical rotation region 33A of the second optical rotator 33 so that the rotated polarization direction thereof returns to the-original polarization direction.

The polarizing filter portion 51 reliably removes the unnecessary light, that is, the light components L1 and L3, and transmits only the light polarized in the original polarization direction. The light receiver 11 thus receives only the light reflected by the recording layer of interest.

FIGS. 13A and 13B illustrate only the portion of the light on the plus side of the y-axis, although the structure described above can also separate the portion of the light on the minus side of the y-axis by rotating the polarization direction thereof so that the light receiver 11 receives only the light reflected by the layer of interest. Accordingly, the light receiver 11 can detect all light reflected by the layer of interest.

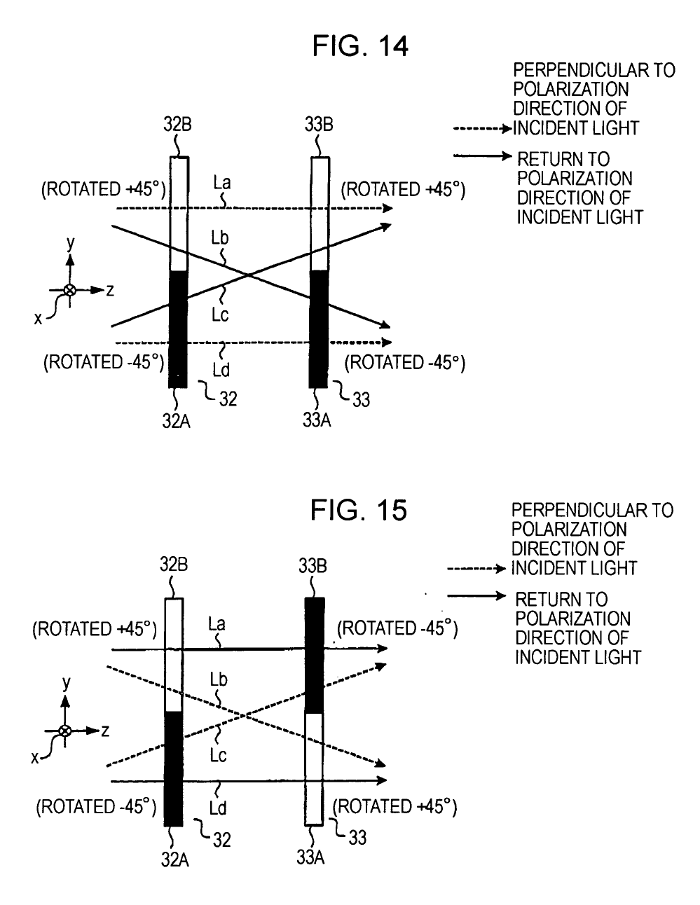

FIGS. 14 and 15 are schematic sectional views of examples of the optical rotators 31 and 32.

In the example illustrated in FIG. 14, the first optical rotation region 32A of the first optical rotator 32 and the first optical rotation region 33A of the second optical rotator 33 rotate the polarization direction of light −45° (45° counterclockwise when viewed in the direction in which the light travels). The second optical rotation region 32B of the first optical rotator 32 and the second optical rotation region 33B of the second optical rotator 33 rotate the polarization direction of light +45°(45° clockwise when viewed in the direction in which the light travels).

A light component Ld passes through the first optical rotation regions 32A and 33A of the optical rotators 32 and 33, respectively, and a light component La passes through the second optical rotation regions 32B and 33B. The polarization directions of the light components La and Ld are thus rotated 90° from the polarization direction of the incident light. A light component Lb passes through the second optical rotation region 32B of the first optical rotator 32 and the first optical rotation region 33A of the second optical rotator 33, and a light component Lc passes through the first optical rotation region 32A of the first optical rotator 32 and the second optical rotation region 33B of the second optical rotator 33. The polarization directions of the light components Lb and Lc thus return to the original polarization direction because the first optical rotation regions 32A and 33A and the second optical rotation regions 32B and 33B rotate the polarization direction of light in opposite directions.

In this case, a polarizing filter or a polarizing beam splitter may be disposed as the separating part 51 so as to extract only the light polarized in the polarization direction of the incident light. The separating part 51 can thus separate only the light reflected by the layer of interest.

In the example illustrated in FIG. 15, the first optical rotation region 32A of the first optical rotator 32 and the second optical rotation region 33B of the second optical rotator 33 rotate the polarization direction of light −45°. The second optical rotation region 32B of the first optical rotator 32 and the first optical rotation region 33A of the second optical rotator 33 rotate the polarization direction of light +45°.

The light component Ld passes through the first optical rotation regions 32A and 33A of the optical rotators 32 and 33, respectively, and the light component La passes through the second optical rotation regions 32B and 33B. The polarization directions of the light components La and Ld thus return to the polarization direction of the incident light. The light component Lb passes through the second optical rotation region 32B of the first optical rotator 32 and the first optical rotation region 33A of the second optical rotator 33, and the light component Lc passes through the first optical rotation region 32A of the first optical rotator 32 and the second optical rotation region 33B of the second optical rotator 33. The polarization directions of the light components Lb and Lc are thus rotated 90° from the original polarization direction.

In this case, a polarizing filter or a polarizing beam splitter may be disposed as the separating part 51 so as to extract only the light polarized perpendicularly to the polarization direction of the incident light. The separating part 51 can thus separate only the light reflected by the layer of interest.

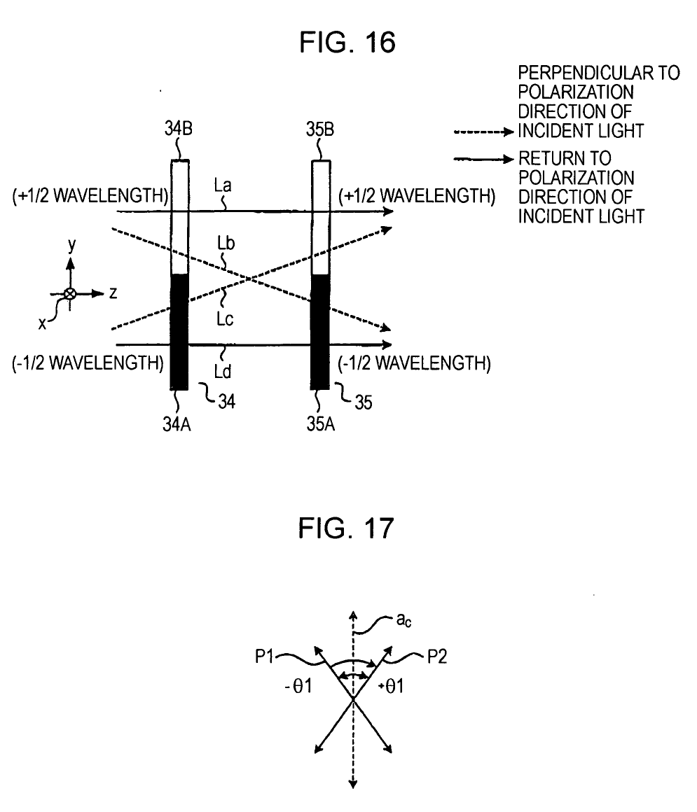

FIG. 16 illustrates another example in which the splitting part 30 includes two wave plates. In this example, a first wave plate 34 and a second wave plate 35 are each divided into two regions along the xz-plane. The first wave plate 34 includes a first region 34A that introduces a phase shift of a −½ wavelength and a second region 34B that introduces a phase shift of a +½ wavelength. The second wave plate 35 includes a first region 35A that introduces a phase shift of a −½ wavelength and a second region 35B that introduces a phase shift of a +½ wavelength. The conversion of the polarization direction of light using a half wave plate will be described below with reference to FIG. 17, where the sign + indicates clockwise rotation and the sign − indicates counterclockwise rotation. In FIG. 17, the half wave plate converts incident light P1 polarized in a direction inclined at −θ1° to the optical crystal axis a_{c} of the wave plate into light P2 polarized in a direction inclined at +θ1° to the optical crystal axis a_{c}. The −θ1 and +θ1 directions are symmetrical with respect to the optical crystal axis a_{c}. The amount of change in polarization direction is +2θ1.

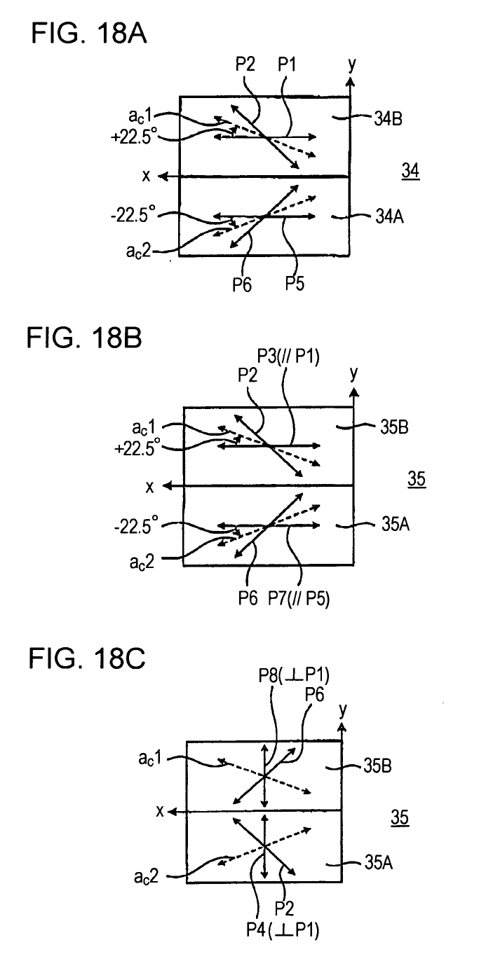

In FIG. 18A, for example, the optical crystal axis a_{c}1 of the second region 34B of the first wave plate 34 shown in FIG. 16 is inclined at +22.5° with respect to the x-axis, and the optical crystal axis a_{c}2 of the first region 34A is inclined at −22.5° with respect to the x-axis. Light polarized in the x-axis direction, as indicated by the arrows P1 and P5, is polarized in a direction inclined at +45° with respect to the x-axis when passing through the second region 34B and is polarized in a direction inclined at −45° with respect to the x-axis when passing through the first region 34A.

FIG. 18B illustrates the change of polarization direction in the case where the light passing through the first region 34A of the first wave plate 34 passes through the first region 35A of the second wave plate 35, as indicated by the arrow Ld in FIG. 16, and the light passing through the second region 34B of the first wave plate 34 passes through the second region 35B of the second wave plate 35, as indicated by the arrow La in FIG. 16. The polarization direction of the light passing through the regions having optical crystal axes oriented in the same direction returns to the original polarization direction of the light incident on the first wave plate 34, as indicated by the arrows P3 and P7 in FIG. 18B.

FIG. 18C illustrates the change of polarization direction in the case where the light passing through the first region 34A of the first wave plate 34 passes through the second region 35B of the second wave plate 35, as indicated by the arrow Lc in FIG. 16, and the light passing through the second region 34B of the first wave plate 34 passes through the first region 35A of the second wave plate 35, as indicated by the arrow Lb in FIG. 16. The polarization direction of the light passing through the regions having optical crystal axes oriented in different directions is perpendicular to the original polarization direction of the light incident on the first wave plate 34, as indicated by the arrows P4 and P8 in FIG. 18C.

In this case,/the light polarized perpendicularly to the polarization direction of the incident light may be reflected or transmitted to the polarizing filter portion 59 (not shown). The polarizing filter portion 59 can thus separate only light reflected at a particular position of an illuminated medium such as an optical recording medium, as in the embodiment illustrated in FIGS. 13a and 13B.

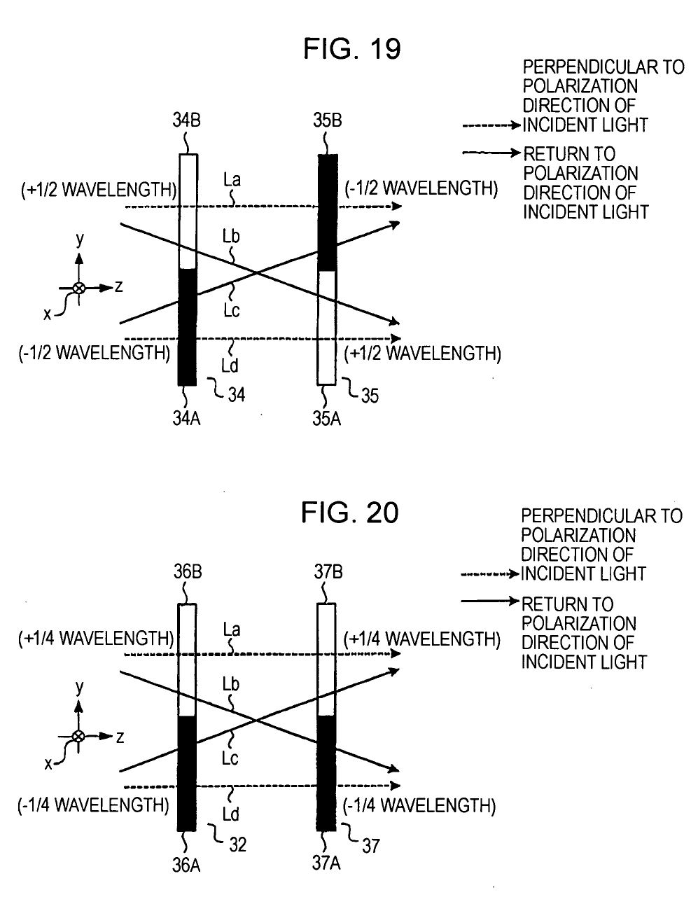

Referring to FIG. 19, the light of interest can also be separated by changing the regions of the wave plates 34 and 35. In FIG. 19, components corresponding to those in FIG. 16 are indicated by the same reference numerals to avoid redundant description. In this example, the light indicated by the arrow La and the light indicated by the arrow Ld are polarized perpendicularly to the polarization direction of the incident light when passing through the wave plates 34 and 35. The light indicated by the arrow Lb and the light indicated by the arrow Lc return to the original polarization direction when passing through the wave plates 34 and 35. In this case, the light polarized in the polarization direction of the incident light may be reflected or transmitted to the polarizing filter portion 59 (not shown). The polarizing filter portion 59 can thus separate only light reflected at a particular position of an illuminated medium such as an optical recording medium.

FIG. 20 illustrates another example in which the splitting part 30 includes two quarter wave plates. In this example, a first wave plate 36 and a second wave plate 37 are each divided into two regions along the xz-plane. The first wave plate 36 includes a first region 36A that introduces a phase shift of a −¼ wavelength and a second region 36B that introduces a phase shift of a +¼ wavelength. The second wave plate 37 includes a first region 37A that introduces a phase shift of a −¼ wavelength and a second region 37B that introduces a phase shift of a +¼ wavelength.

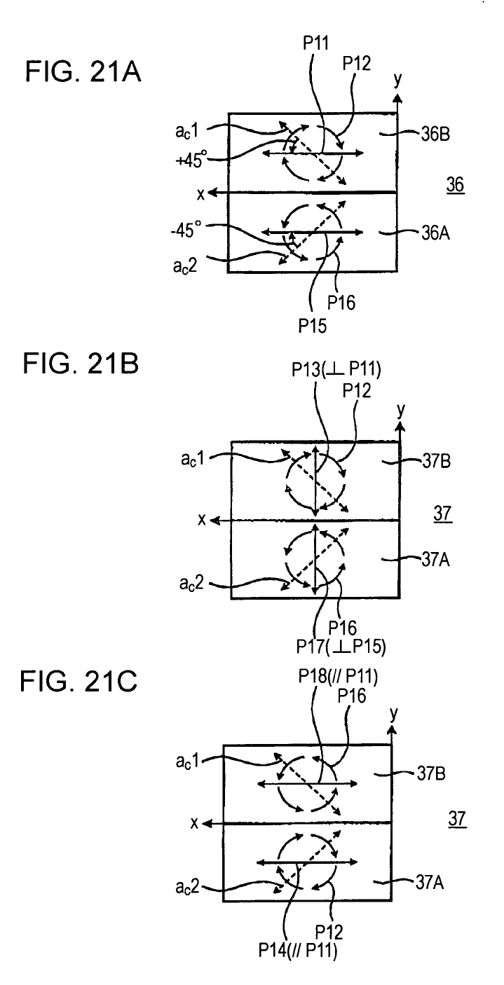

In FIG. 21A, for example, the optical crystal axis a_{c}1 of the second region 36B of the first wave plate 36 is inclined at +45° with respect to the x-axis, and the optical crystal axis a_{c}2 of the first region 36A is inclined at −45° with respect to the x-axis. Light polarized in the x-axis direction, as indicated by the arrows P11 and P15, is circularly polarized clockwise when passing through the second region 36B and is circularly polarized counterclockwise when passing through the first region 36A.

FIG. 21B illustrates the change of polarization direction in the case where the light passing through the first region 36A of the first wave plate 36 passes through the first region 37A of the second wave plate 37, as indicated by the arrow Ld in FIG. 20, and the light passing through the second region 36B of the first wave plate 36 passes through the second region 37B of the second wave plate 37, as indicated by the arrow La in FIG. 20. The polarization direction of the light passing through the regions having optical crystal axes oriented in the same direction is perpendicular to the original polarization direction of the light incident on the first wave plate 36, as indicated by the arrows P13 and P17 in FIG. 21B.

FIG. 21C illustrates the change of polarization direction in the case where the light passing through the first region 36A of the first wave plate 36 passes through the second region 37B of the second wave plate 37, as indicated by the arrow Lc in FIG. 20, and the light passing through the second region 36B of the first wave plate 36 passes through the first region 37A of the second wave plate 37, as indicated by the arrow Lb in FIG. 20. The polarization direction of the light passing through the regions having optical crystal axes oriented in different directions returns to the original polarization direction of the light incident on the first wave plate 36, as indicated by the arrows P14 and P18 in FIG. 21C.

In this case, the light polarized in the polarization direction of the incident light may be reflected or transmitted to the polarizing filter portion 59 (not shown). The polarizing filter portion 59 can thus separate only light reflected at a particular position of an illuminated medium such as an optical recording medium, as in the embodiment illustrated in FIGS. 13a and 13B.

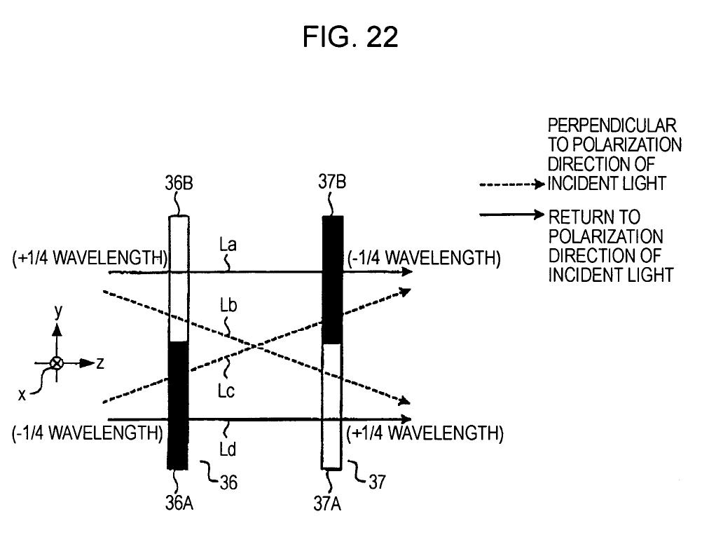

Referring to FIG. 22, the light of interest can also be separated by changing the regions of the wave plates 36 and 37. In FIG. 22, components corresponding to those in FIG. 20 are indicated by the same reference numerals to avoid redundant description. In this example, the light indicated by the arrow La and the light indicated by the arrow Ld return to the polarization direction of the incident light when passing through the wave plates 36 and 37. The light indicated by the arrow Lb and the light indicated by the arrow Lc are polarized perpendicularly to the polarization direction of the incident light when passing through the wave plates 36 and 37. In this case, the light polarized perpendicularly to the polarization direction of the incident light may be reflected or transmitted to the polarizing filter portion 59 (not shown). The polarizing filter portion 59 can thus separate only light reflected at a particular position of an illuminated medium such as an optical recording medium.

Although two optical rotators or wave plates and a single polarizing filter are used for the splitting part 30 and the separating part 51, respectively, in this embodiment, any combination of optical rotators or wave plates that operates similarly may be used, and the polarizing filter portion 59 may be replaced with a polarizing beam splitter, as described above.

In this embodiment, a light component reflected by the reflective surface of interest may be allowed to pass through optical rotators or wave plates across the optical axis. As in the sixth embodiment, therefore, the light-separating unit 50 may be translated along the optical axis in the z-axis direction so that the light receiver 11 can receive only the light component L1 or L3.

It should be noted that wave plates differ from optical rotators as described below. Wave plates refer to birefringent plates that introduce a predetermined optical phase shift between linearly polarized light components vibrating in orthogonal directions when the light components pass through the plates.

On the other hand, optical rotators operate by rotating the plane of polarization of light by a predetermined angle when the light passes therethrough. Optical rotators differ from wave plates in that they introduce no optical phase shift (retardation) to the light passing therethrough, which therefore remains linearly polarized while the polarization direction thereof is rotated. That is, only the optical rotatory power of optical rotators varies for different wavelengths. Optical rotators have the advantage that linearly polarized light may be incident with the polarization direction thereof oriented in any direction within the plane of the rotators because, unlike wave plates, they have no optical axis in the plane thereof. Optical rotators thus advantageously eliminate the need for aligning the optical axes thereof to facilitate assembly and production.

The simple optical system with the two optical rotators or wave plates and the single polarizing filter or polarizing beam splitter can suppress a decrease in recording/playback characteristics when applied to an optical pickup device or an optical recording/playback apparatus to perform the recording/playback of a multilayer recording medium.

In this embodiment, additionally, the separating part 51 separates light components passing through the splitting part 30 on the basis of the optical paths thereof. The separating part 51 can thus also separate the light component L1 or L3 similarly.

### Eighth Embodiment

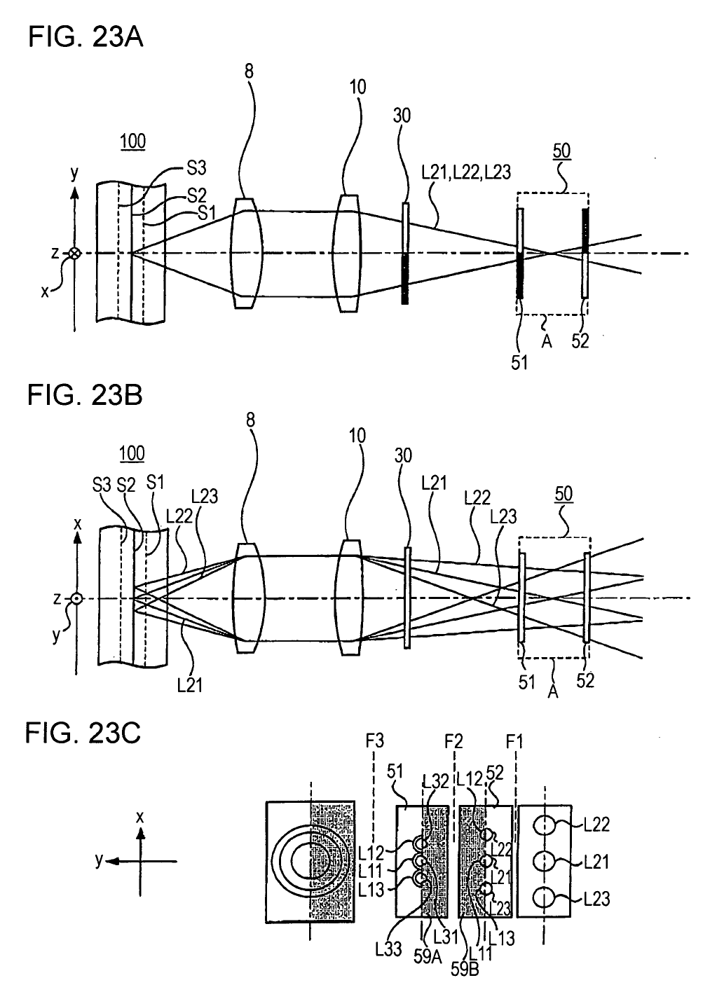

FIGS. 23A to 23C are schematic diagrams of a light-separating separating unit and an optical system including the unit according to an eighth embodiment of the present invention. In FIGS. 23A to 23C, components corresponding to those in FIG. 10 are indicated by the same reference numerals to avoid redundant description.

In this embodiment, the second reflective surface S2 of the optical recording medium 100 is illuminated with three light beams arranged along the x-axis, including a main beam for recording/playback and two side beams on both sides thereof. The two side beams are reflected and received for processes such as tracking and focusing.

The splitting part 30 splits the light beams reflected by the second reflective surface S2 in a cross-section parallel to the optical axis thereof and the direction in which the light beams are arranged, that is, in the xz-plane. As in the embodiment illustrated in FIG. 10, for example, the splitting part 30 includes an optical rotator and a transparent portion. The polarization direction of light passing through the optical rotator is rotated 90° while the polarization direction of light passing through the transparent portion is not rotated. FIGS. 23A and 23B illustrate only a light component L21 of the main beam which is reflected by the second reflective surface S2 and light components L22 and L23 of the two side beams which are reflected by the second reflective surface S2.

Referring to FIG. 23C, the separating parts 51 and 52 of the light-separating unit 50 reliably remove unnecessary light components L11 to L13 reflected by the first reflective surface S1 and unnecessary light components L31 to L33 reflected by the first reflective surface S1. The light receiver 11 thus detects only the light components L21 to L23 reflected by the second reflective surface S2.

The simple optical system with the splitting part 30 and the light-separating unit 50 can suppress a decrease in recording/playback characteristics when applied to an optical pickup device or an optical recording/playback apparatus to perform the recording/playback of a multilayer recording medium by illuminating the medium with at least two light beams. Similarly, when an optical recording medium having a single recording layer is illuminated with at least two light beams, the optical system described above can reliably remove the unnecessary light reflected by the surfaces other than the reflective surface of interest, for example, the interface between the recording layer and a protective layer, to suppress a decrease in recording/playback characteristics.

According to the embodiments described above, after light is split, unnecessary light coming from layers other than the layer of interest can be reliably removed on the basis of differences in focal position without affecting light coming from the layer of interest.

The unnecessary light can readily be removed by, for example, blocking the light or changing the optical path thereof through reflection or refraction. In addition, light can be split using a relatively simple optical element such as a prism or a diffractive element, or can also be separated on the basis of differences in polarization direction using optical rotators or wave plates without splitting the optical axis thereof. Furthermore, a splitting part and a light-separating unit can be integrated into a single unit to easily and reliably remove unnecessary light components, which wound otherwise overlap the light component of interest on a light receiver in the related art.

The present invention should not be construed as being limited by the embodiments described above. For example, optical elements other than the examples described above may be used to split or remove light within the scope of the present invention. In addition, methods and units for separating light according to embodiments of the present invention are not limited to application to the optical pickup devices and optical recording/playback apparatuses described above, and may be applied to other various types of optical pickup devices and optical recording/playback apparatuses. Furthermore, methods and units for separating light according to embodiments of the present invention may of course be applied to any optical system for removing unnecessary light coming from positions deviating along the optical axis from the position from which the light to be detected comes.

It should be understood by those skilled in the art that various modifications, combinations, sub-combinations and alterations may occur depending on design requirements and other factors insofar as they are within the scope of the appended claims or the equivalents thereof.

What is claimed is:

1. A method for separating light coming from an illuminated multilayer medium having a plurality of reflective surfaces to reach a light receiver through a focusing lens, the method comprising the steps of:
splitting the light traveling toward the light receiver through the focusing lens into at least two portions along the optical axis thereof; and
separating a light component coming from a particular position of the illuminated medium from each of the split portions of the light by removing a light component focused at a position closer to the focusing lens than the focal position of the light component coming from the particular position between the two focal positions and/or removing a light component focused at a position closer to the light receiver than the focal position of the light component coming from the particular position between the two focal positions.

2. The method for separating the light according to claim 1, wherein the light traveling toward the light receiver through the focusing lens is split into at least two portions along the optical axis thereof using a prism.

3. The method for separating the light according to claim 1, wherein the light traveling toward the light receiver through the focusing lens is split into at least two portions along the optical axis thereof using a diffractive part.

4. The method for separating the light according to claim 1, wherein the light traveling toward the light receiver through the focusing lens is split into at least two portions along the optical axis thereof by selectively allowing the light to pass through a region that changes polarization; and
the light component coming from the particular position is separated from each of the split portions of the light using a polarizing filter portion by removing the light component focused at the position closer to the focusing lens than the focal position of the light component coming from the particular position between the two focal positions and/or removing the light component focused at the position closer to the light receiver than the focal position of the light component coming from the particular position between the two focal positions.

5. The method for separating the light according to claim 4, wherein
the light passes through at least two optical rotators or wave plates as the region that changes polarization; and
the light component coming from the particular position is separated from the light components coming from positions other than the particular position using the polarizing filter portion by changing the polarization direction of either the light component coming from the particular position or the light components coming from the positions other than the particular position and then returning the changed polarization direction to the original polarization direction while changing the polarization direction of the other to a direction perpendicular to the original polarization direction.

6. The method for separating the light according to claim 1, wherein
the light traveling toward the light receiver through the focusing lens includes at least two light beams, each being split into at least two portions along a cross-section parallel to the optical axes thereof and a direction in which the light beams are arranged; and
the light component coming from the particular position is separated from each of the split portions of the light beams by removing the light component focused at the position closer to the focusing lens than the focal position of the light component coming from the particular position between the two focal positions and/or removing the light component focused at the position closer to the light receiver than the focal position of the light component coming from the particular position between the two focal positions.

7. A light-separating unit comprising a separating part for removing, from light coming from an illuminated multilayer medium having a plurality of reflective surfaces to reach a light receiver through a focusing lens, a light component focused at a position closer to the focusing lens than the focal position of a light component coming from a particular position of the illuminated medium between the two focal positions and/or removing a light component focused at a position closer to the light receiver than the focal position of the light component coming from the particular position between the two focal positions.

8. The light-separating unit according to claim 7, further comprising a splitting part for splitting the light traveling toward the light receiver through the focusing lens into at least two portions along the optical axis thereof.

9. The light-separating unit according to claim 7, wherein the separating part includes a light-shielding portion.

10. The light-separating unit according to claim 7, wherein the separating part includes a reflective surface.

11. The light-separating unit according to claim 7, wherein the separating part includes a refractive surface.

12. The light-separating unit according to claim 7, wherein the separating part includes a polarizing filter portion.

13. The light-separating unit according to claim 12, further comprising a splitting part for splitting the light reaching the light receiver through the focusing lens along the optical axis thereof, the splitting part including at least one optical rotator or wave plate for changing polarization.

14. The light-separating unit according to claim 13, wherein the splitting part includes at least two optical rotators or wave plates to change the polarization direction of either the light component coming from the particular position or the light components coming from positions other than the particular position and then return the changed polarization direction to the original polarization direction while changing the polarization direction of the other to a direction perpendicular to the original polarization direction.

15. An optical pickup device comprising:
a light source for emitting light;
a light receiver; and
an optical system including
an objective lens disposed opposite a multilayer optical recording medium having a plurality of reflective surfaces, the light emitted from the light source being guided to the objective lens and made incident at a predetermined position of the optical recording medium,
a focusing lens for collecting the light coming from the optical recording medium through the objective lens onto the light receiver,
a splitting part for splitting the light traveling toward the light receiver through the focusing lens into at least two portions along the optical axis thereof, and
a light-separating unit for separating a light component reflected by a recording layer of interest of the optical recording medium from each of the split portions of the light by removing a light component focused at a position closer to the focusing lens than the focal position of the light component reflected by the recording layer of interest between the two focal positions and/or removing a light component focused at a position closer to the light receiver than the focal position of the light component reflected by the recording layer of interest between the two focal positions.

16. The optical pickup device according to claim 15, wherein the splitting part includes at least two optical rotators or wave plates to split the light reaching the light receiver through the focusing lens along the optical axis thereof by changing the polarization direction of either the light component reflected by the recording layer of interest or the light components coming from positions other than the recording layer of interest and then returning the changed polarization direction to the original polarization direction while changing the polarization direction of the other to a direction perpendicular to the original polarization direction.

17. An optical recording/playback apparatus comprising:
a light source for emitting light;
a light receiver; and
an optical system for recording and/or playback, the optical system including
an objective lens disposed opposite a multilayer optical recording medium having a plurality of reflective surfaces, the light emitted from the light source being guided to the objective lens and made incident at a predetermined position of the optical recording medium,
a focusing lens for collecting the light coming from the optical recording medium through the objective lens onto the light receiver,
a splitting part for splitting the light traveling toward the light receiver through the focusing lens into at least two portions along the optical axis thereof, and
a light-separating unit for separating a light component reflected by a recording layer of interest of the optical recording medium from each of the split portions of the light by removing a light component focused at a position closer to the focusing lens than the focal position of the light component reflected by the recording layer of interest between the two focal positions and/or removing a light component focused at a position closer to the light receiver than the focal position of the light component reflected by the recording layer of interest between the two focal positions.

18. The optical recording/playback apparatus according to claim 17, wherein the splitting part includes at least two optical rotators or wave plates to split the light reaching the light receiver through the focusing lens along the optical axis thereof by changing the polarization direction of either the light component reflected by the recording layer of interest or the light components coming from positions other than the recording layer of interest and then returning the changed polarization direction to the original polarization direction while changing the polarization direction of the other to a direction perpendicular to the original polarization direction.
